(19) United States
(12) Patent Application Publication
(10) Pub. No.: US 2025/0216552 A1
(43) Pub. Date: Jul. 3, 2025

(54) A METHOD FOR TRACKING OF AT LEAST ONE OBJECT WITH AT LEAST ONE DETECTION DEVICE, DETECTION DEVICE AND VEHICLE WITH AT LEAST ONE DETECTION DEVICE

(71) Applicant: VALEO DETECTION SYSTEMS GMBH, Bietigheim-Bissingen (DE)

(72) Inventors: Sergio Fernandez, Bietigheim-Bissingen (DE); Victor Enrique Lauria-Valenzuela

(73) Assignee: VALEO DETECTION SYSTEMS GMBH, Bietigheim-Bissingen (DE)

(21) Appl. No.: 18/852,497

(22) PCT Filed: Mar. 29, 2023
(86) PCT No.: PCT/EP2023/058084

§ 371 Date: Sep. 30, 2024

(30) Foreign Application Priority Data
Apr. 1, 2022 (DE) 10 2022 107 770.5

(51) Int. Cl. G01S 17/66; G01B 11/24; G01S 17/931

(52) U.S. Cl. CPC G01S 17/66; G01B 11/24; G01S 17/931

(57) ABSTRACT

A method for tracking of an object with a detection device, using electromagnetic scanning signals, a plurality of target data is determined, where each target data comprises a position value. From at least a part of the target data a bounding data is determined. The object is tracked by determining a development of the bounding data. Where for determining the bounding data at least a part of the target data is grouped into clusters, a weighting value for the target data of at least one cluster is determined from the target data of the respective cluster, the bounding data is determined from weighted target data, where the weighted target data each are determined from the respective target data weighted by the weighting value of the cluster to which the target data belongs.

A method for tracking of at least one object with at least one detection device, detection device and vehicle with at least one detection device

### TECHNICAL FIELD

The present invention relates to a method for tracking of at least one object with at least one detection device, in particular a LiDAR system, in particular of a vehicle, in which by use of electromagnetic scanning signals a plurality of target data is determined, where each target data comprises at least one position value characterizing a position of an object target of the at least one object in at least one predefined reference system.

Further, the invention relates to a detection device, in particular a LiDAR system, in particular of a vehicle, which comprises means for sending electromagnetic scanning signals, means for receiving reflected electromagnetic scanning signals and means for determining target data for object targets of objects from electromagnetic scanning signals.

Furthermore, the invention relates to a vehicle with at least one detection device, in particular at least one LiDAR system, where the at least one detection device comprises means for sending electromagnetic scanning signals, means for receiving reflected electromagnetic scanning signals and means for determining target data for object targets of objects from electromagnetic scanning signals.

### STATE OF TECHNOLOGY

From DE 10 2019 131 334 A1 a method for tracking extended objects with at least one detection device and a detection device are known. In the method, an object is detected during successive measurement cycles and at least one tracking state is determined from at least a part of the detections of the object, which characterizes a position and a movement of the at least one object. During a measurement cycle, at least one transmit signal is transmitted into a monitoring area of the at least one detection device, at least one receive signal is received which originates from at least one transmit signal which is reflected at at least one reflection point of the at least one object. At least one detection for the at least one reflection point is determined from the at least one received signal. Advantageously, the detection device may comprise at least one radar sensor and/or at least one LiDAR sensor. Advantageously, the detection device can be used in a vehicle, in particular a motor vehicle.

It is an objective of the invention to provide a method, a detection device and a vehicle of the type mentioned above, with which the tracking of objects can be improved.

### DISCLOSURE OF INVENTION

The objective of the invention is achieved with the method by that
from at least a part of target data at least one bounding data is determined, which characterizes the shape of the at least one object,
the at least one object is tracked by determining a development of the at least one bounding data,
where for determining the at least one bounding data at least a part of target data is grouped into clusters,
at least one weighting value for the target data of at least one cluster is determined from the target data of the respective cluster,
the at least one bounding data is determined from weighted target data, where the weighted target data each are determined from the respective target data weighted by the at least one weighting value of the cluster to which the target data belongs.

According to the invention, at least one bounding data is determined from at least a part of target data. The bounding data serve as a simplified model, in particular a box, of the at least one object, at which the scanning signals are reflected. The bounding data simplify the tracking and segmenting of the at least one object compared to tracking and segmenting the whole set of target data. The bounding data can characterize properties like velocity and orientation of the at least one object to be tracked. With the invention it is possible to compensate for negative effects of irregular measurements, in particular measurements of shapes, which deviate from the simplified model of the at least one object, for example from a box-shaped-model. Such irregular measurements can destabilize the tracking function. With the invention, the measurement is corrected before the matching of the model. Further sterilizations are thus not necessary.

With the invention irregular shapes of the model generated by parts of a dynamic object can be corrected. For objects in form of vehicles, for example, irregular shapes can be created by protruding parts such as side mirrors, towbars or the like. With the invention, a low weighting is applied to these measured parts from the matching to a model, for example a box model. A low weighting reduces the influence of these measured parts on the matching compared to the main part of the at least one object.

An object target in the sense of the invention is an area or a reflection point of an object from which scanning signals may be reflected. An object may have one or more such object targets.

One advantage of the method according to the invention is the prevention of non-optimal matching, which might be difficult to compensate at a later stage of object tracking algorithm. With the method according to the invention, the measurement is directly tackled and corrected to have a good matching and further tracking. This is more robust and handles the detection device, in particular the LiDAR system, high sensitivity to measure small shape irregularities (i.e. side mirrors, towbars or the like).

The method according to the invention can be used with detection devices in form of LiDAR systems. The detection device according to the invention can be a LiDAR system. With a LiDAR system positions, in particular directions and distances, and velocities of objects relative to a predefined reference system can be obtained. The LiDAR system can use electromagnetic scanning signals in form of light signals, in particular laser signals. Light signals can be reflected by objects. However, the method according to the invention can also be used with detection devices in form of radar systems. The detection device according to the invention can also be a radar system. With a radar system positions, in particular directions and distances, and velocities of objects relative to a redefined reference system can be obtained. The radar system can use electromagnetic scanning signals in form of radar signals. Radar signals can be reflected by objects.

Advantageously, the predefined reference system can be a reference system of the at least one detection device and/or a reference system of a vehicle carrying the at least one detection device. In this way, positions of object targets can be clearly defined.

Advantageously, the at least one reference system can be coordinate system, in particular a polar coordinate system, a spherical coordinate system or a Cartesian coordinate system. The coordinate origin of the coordinate system can be related with the at least one detection device and/or with the vehicle. At least one dimension, in particular at least one axis, of the coordinate system can be related to at least one vehicle axis, e.g. a longitudinal vehicle axis, in particular running parallel to it.

The method and the detection device according to the invention may be used for vehicles, in particular motor vehicles. Advantageously, the method and the detection device according to the invention can be used on land vehicles, in particular passenger cars, lorries, buses, motorcycles or the like, aircraft and/or watercraft. The method according to the invention may also be used for detection devices of vehicles which can be operated autonomously or partially autonomously. However, the method and the detection device according to the invention are not limited to vehicles. They can also be used in stationary operation, robotics and/or machines, in particular construction or transport machines, such as cranes, excavators or the like. The detection device may advantageously be connected to or be part of at least one electronic control device of a vehicle or a machine, in particular a driver assistance system. In this way autonomous or partially autonomous operation of the vehicle or the machine can be enabled.

The detection device can be used to detect stationary or moving objects, in particular vehicles, persons, animals, obstacles, road unevenness, in particular potholes or stones, road limitations, open spaces, in particular parking spaces, precipitations or the like.

According to a favorable embodiment at least one weighting value for the target data, in particular the contour target data, of at least one cluster can be determined
from a number of target data, in particular of object target data, in the at least one cluster
and/or
from an extension of a range of comparable position values, in particular height values, of target data, in particular object target data, of the at least one cluster, at least in one dimension, wherein the extension of a range of position values characterizes a spatial extent of the distribution of the object targets to which the target data, in particular the object target data, of the at least one cluster belong, in particular a height extension,
and/or
from a correlation of the position values of at least a part of target data, in particular the object target data, of the at least one cluster with respect to each other, wherein the correlation characterizes an alignment of the object targets to which the target data of the at least one cluster belong with respect to each other,
and/or
from a cluster position value which characterizes the position of the cluster in relation to at least a part of the other clusters. In this way, different weighting criteria can be applied to the target data which represent the contour of a detected object. The criterion or combination of criteria to be used can be chosen to suit the situation and/or the detected object.

Advantageously, at least one weighting value can be determined from a number of target data in at least one cluster. The smaller the number of target data in a cluster, the smaller the influence of the target data of this cluster on the bounding data.

Advantageously, at least one weighting value can be determined from an extension of a range of comparable position values of the target data of the at least one cluster at least in one dimension. In particular said position values can be height values. The extension of a range of position values can characterize a spatial extent, in particular a height extension, of the distribution of the object targets to which the target data of the at least one cluster belong. The smaller the spatial area over which the object targets of a cluster span, the smaller the impact of the respective target data of the respective cluster on the bounding data.

Advantageously, at least one weighting value can be determined from a correlation of the position values of at least a part of the target data of the at least one cluster with respect to each other, wherein the correlation characterizes an alignment of the object targets to which the target data of the at least one cluster belong with respect to each other. This allows target data that deviate from series of other target data which represent the contour shape of the detected object to be given lower impact on the bounding data.

Advantageously, at least one weighting value can be determined from a cluster position value which characterizes the position of the cluster in relation to at least a part of the other clusters. This allows object targets that are off the shape of an object to be weighted lower.

According to another favorable embodiment at least one weighting value for target data, in particular the contour target data, of at least one cluster can be determined by statistical methods, in particular, the at least one weighting value can be determined from mean values and/or variances. In this way, weighting criteria can be determined in an efficient way. Mean values and variances can be used to infer whether target data, in particular contour target data, of at least one cluster belong to object targets on a main part of a detected object. Thus, target data, in particular control target data, from object targets that do not belong to the main part of a detected object can be weighted lower, in particular can be ignored.

According to another favorable embodiment for determining the at least one bounding data only those target data, in particular contour target data, can be considered whose weighting values lie within a predetermined range of values, in particular above a predetermined threshold or below a predetermined threshold. Thus, the influence of target data, in particular contour target data, of object targets that do not belong to a main part of a detected object on the bounding data can be minimized.

According to another favorable embodiment
a plurality of object target data each characterizing one object target of the at least one object can be determined by use of electromagnetic scanning signals,
at least one contour target data characterizing a contour of the at least one object can be determined from at least a part of the object target data
and the at least one bounding data can be determined, in particular computed, from the at least one contour target data. The contour of the at least one object can be approximated by determining the contour target data from the plurality of object target data. The object target data are the data measured by use of the electromagnetic scanning signals. The bounding data can be determined from the contour target data approximating the contour of the at least one object. In this way, negative effects of irregular measurements can be further reduced.

According to another favorable embodiment a plurality of object target data each comprising at least one position value characterizing a three-dimensional position of one object target can be determined by use of electromagnetic scanning signals, for determining at least one contour target data the dimension of at least a part of the object target data can be reduced by one. In this way, object target data resulting from object targets in different levels of the dimension to be reduced, in particular in different heights, can be combined to respective contour target data in one level, in particular in the same height.

According to another favorable embodiment at least a part of the at least one bounding data can be used for characterizing at least one tracking area, in particular a tracking box, which is used for tracking the at least one detected object
and/or
at least one bounding data can comprise at least one position value, which characterizes a position of a tracking area, in particular a tracking box, which is used for tracking the at least one detected object relative to at least one reference system, and/or at least one orientation value, which characterizes an orientation of the tracking area in the at least one reference system, and/or at least one size value, which characterizes a size of the tracking area. With the tracking area object targets of interest can be identified. In this way, a movement of an object can be tracked more efficiently. The position values can be used to characterize the position of the tracking area near the object targets of interest. The orientation values can be used characterize the orientation of the tracking area. The size values can be used characterize the size of tracking area.

Advantageously, at least one bounding data can comprise the coordinates, in particular Cartesian coordinates, polar coordinates or spherical coordinates, of a reference point of the tracking area, in particular the tracking box, in a reference system of the LiDAR system and/or a reference system of the vehicle with the LiDAR system. The reference point of the tracking area can be a center or an edge of the tracking area or the like. Additionally, at least one bounding data can comprise at least one orientation value, in particular an yaw angle, which characterizes the orientation of the tracking area in the reference system, in particular the reference system of the LiDAR system and/or the vehicle with the LiDAR system. Further, at least one bounding data can comprise at least one size value, in particular a length, a width and a height, which characterizes the size of the tracking area.

Advantageously, at least one bounding data can be or comprise a tuple (x′, y′, z′, α, l, w, h), where x′, y′ and z′ are the coordinates (Cartesian coordinates or spherical coordinates) of the position value, α is the yaw angle and l, w and h are the size values length, width and height of the tracking area. In case of a two-dimensional tracking area, only two position values and two size values are required.

According to another favorable embodiment at least one target data can be determined which comprises at least one position value, in particular a direction value and/or a distance value, which characterizes a position of an object target in the at least one reference system and/or at least one intensity value which characterizes the intensity of electromagnetic scanning signals which have been reflected at the object target. In this way, object targets can be assigned.

Advantageously, at least one target data can comprise at least one position value, in particular a direction value and/or a distance value. In this way the position of the respective object target can be identified. At least one direction value can be realized by an angle, in particular an azimuth and/or and elevation angle. In this way, the position of the object target can be identified in a spherical coordinate system or a polar coordinate system. At least one distance value can be realized as a distance of the object target to a coordinate origin of the at least one reference system.

Alternatively or alternatively, at least one target data can comprise at least one position value in form of Cartesian coordinates of a Cartesian reference system, in particular a reference system of the LiDAR system and/or a reference system of the vehicle with a lighter system.

Advantageously, a target data can have the form of a tuple (p1, p2, p3, I), where p1, p2, and p3 are position values in Cartesian coordinates or spherical coordinates and I is an intensity value. The intensity value characterizes the intensity of the received electromagnetic scanning signal. In case of a two-dimensional reference system, only two position values are required, in particular either an angle and a distance as polar coordinates or two Cartesian coordinates.

According to another favorable embodiment at least one target data can be determined which comprises at least one position value which characterizes a two-dimensional position of an object target in the at least one two-dimensional reference system or which comprises at least one position value which characterizes a three-dimensional position of an object target in the at least one three-dimensional reference system. In a two-dimensional reference system a direction of an object target in one dimension, in particular in azimuth, can be specified. In a three-dimensional reference system a direction of an object target in two dimensions, in particular in azimuth and elevation, can be specified.

Further, the objective of the invention is achieved by the detection device in that the detection device comprises means for carrying out the method according to the invention.

The detection device according to the invention can be used to efficiently track movements of dynamic objects.

The means for carrying out the method according to the invention can be realized by software and/or hardware.

Furthermore, the objective of the invention is achieved by the vehicle in that the vehicle comprises means for carrying out the method according to the invention.

According to the invention, the vehicle comprises at least one detection device and means for carrying out the method according to the invention. At least a part of the means for carrying out the method may be implemented as part of at least one detection device. The detection device itself is part of the vehicle. Accordingly, part of the detection device is also part of the vehicle.

Additionally or alternatively, at least a part of the means for carrying out the method according to the invention can be realized separately from the at least one detection device, for example with a control device of the vehicle.

Advantageously, the vehicle can comprise at least one driver assistance system. With the driver assistance system information obtained from the at least one detection device can be used for the autonomous or at least partly autonomous operation of the vehicle.

Advantageously, at least one detection device can be connected to at least one driver assistance system. In this way information acquired with the at least one detection device can be transmitted to the at least one driver assistance system.

Otherwise, the features and advantages shown in connection with the method according to the invention, the detection device according to the invention and the vehicle according to the invention and their respective advantageous configurations shall apply mutatis mutandis to each other and vice versa. The individual features and advantages can, of course, be combined with each other, whereby further advantageous effects can occur which go beyond the sum of the individual effects.

### BRIEF DESCRIPTION OF DRAWINGS

The present invention together with the above-mentioned and other objects and advantages may best be understood from the following detailed description of the embodiments, but not restricted to the embodiments, wherein is shown schematically

FIG. 1 a top view of a vehicle with two LiDAR systems and a driver assistance system in a driving situation and a car with a trailer;

FIG. 2 a side view of the vehicle of FIG. 1;

FIG. 3 a side view of the car of FIG. 1 without the trailer in the field of view of one of the LiDAR systems of the vehicle of FIG. 1;

FIG. 4 a point cloud of a detection of the car of FIGS. 1 and 3 obtained with one of the LiDAR systems of the vehicle of FIG. 1 in a top view;

FIG. 5 weighting points characterizing weighted contoured target data determined from the point cloud from FIG. 4 in a top view;

FIG. 6 the weighting points of FIG. 5 with a tracking box obtained using a method according to a first embodiment;

FIG. 7 the point cloud from FIG. 4 with the tracking box from FIG. 6;

FIG. 8 the weighting points of FIG. 5 with a tracking box obtained using a method according to a second embodiment;

FIG. 9 the point cloud from FIG. 4 with the tracking box from FIG. 8;

FIG. 10 the point cloud from FIG. 4 with a tracking box obtained using a method known in the prior art.

In the drawings, equal or similar elements are referred to by equal reference numerals. The drawings are merely schematic representations, not intended to portray specific parameters of the invention. Moreover, the drawings are intended to depict only typical embodiments of the invention and therefore should not be considered as limiting the scope of the invention.

### EMBODIMENT(S) OF INVENTION

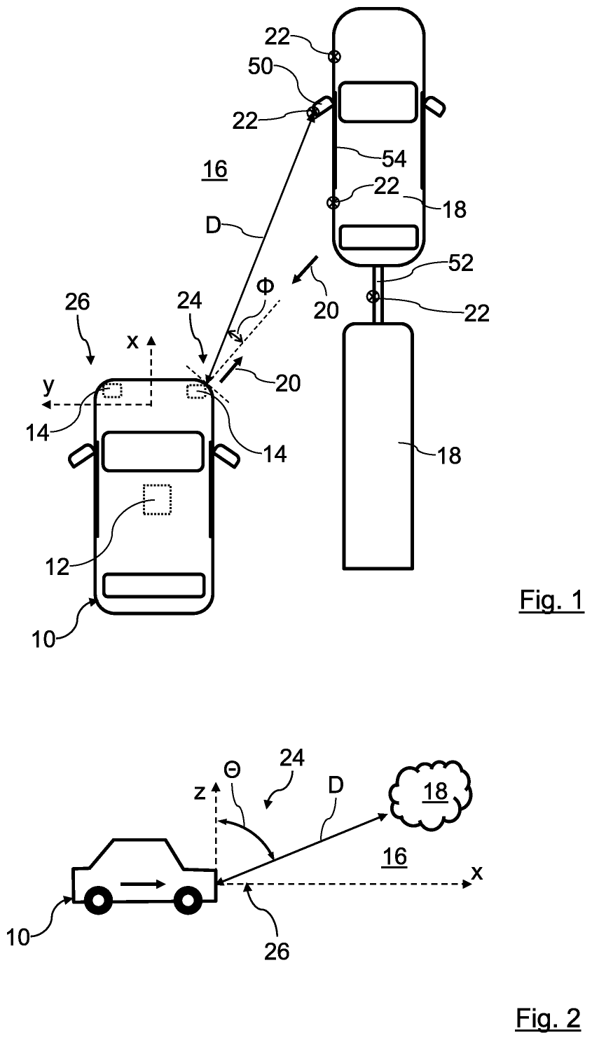

In FIG. 1, a vehicle 10 in the form of a passenger car is shown in a top view in a driving situation with two objects 18 in form of a car with a trailer. FIG. 2 shows the vehicle 10 in a side view with an implied object 18.

The vehicle 10 comprises a driver assistance system 12 and two detection systems in form of LiDAR systems 14. The LiDAR systems 14 are functionally connected to the driver assistance system 12 so that information obtained by the LiDAR systems 14 over a monitoring area 16 in the direction of travel in front and diagonally in front of the vehicle 10 can be transmitted to the driver assistance system 12. The driver assistance system 12 can be used to perform functions of the vehicle 10, for example driving functions, autonomously or semi-autonomously.

By way of example, the LiDAR systems 14 are arranged in the front lights of the vehicle 10 and are directed into the monitoring area 16. The two LiDAR systems 14 are located on opposite sides of the vehicle 10. The LiDAR systems 14 can also be arranged at other locations of the vehicle 10, also in different orientations. The LiDAR systems 14 can be used to detect objects 18 in the monitoring area 16.

The objects 18 can be stationary or moving objects, for example vehicles, people, animals, plants, obstacles, roadway irregularities, for example potholes or stones, roadway boundaries, traffic signs, open spaces, for example parking spaces, precipitation or the like.

The LiDAR systems 14 are identical in terms of their design and mode of operation. The LiDAR systems 14 and their functions are described below using one of the LiDAR systems 14 as an example.

To detect objects 18, electromagnetic scanning signals 20 in form of laser pulses are transmitted with the LiDAR system 14 into the monitoring area 16. Scanning signals 20 which are reflected at object targets 22 of objects 18 in the direction of the LiDAR system 14 are received with the LiDAR system 14. Object information, such as a distance D, a radial velocity and a direction of the detected object target 22 relative to a LiDAR reference system 24 of the LiDAR system 14 and a vehicle reference system 26 of the vehicle 10 can be determined from the received scanning signals 20. Further, a movement of the object 18 can be determined.

An object target 22 in the sense of the invention is an area or a reflection point of an object 18 from which scanning signals 20 may be reflected. An object 18 may have one or more such object targets 22.

For example, the LiDAR reference system 24 is a spherical coordinate system whose coordinates are azimuth P, elevation angle O and distance D. The vehicle reference system 26 for example is a Cartesian coordinate system whose coordinates are designated x, y and z. The x-direction runs in the direction of the longitudinal axis of the vehicle 10. The y-direction runs parallel to the transverse axis of the vehicle 10. The z-direction is perpendicular to the x-direction and perpendicular to the y-direction upwards.

During operation of the vehicle 10, the driver assistance system 12 uses object information, such as distances, velocities, directions and directions of movements of objects 18 relative to the vehicle reference system 26, for autonomous or semi-autonomous operation of the vehicle 10. With the LiDAR systems 14 objects 18, which can for example be extended or elongated (e.g. trailer), can be tracked.

The following describes a method for tracking of objects 18 using one of the LiDAR systems 14.

With a transmitting device of the LiDAR system 14 scanning signals 20 are sent in the monitoring area 16. Scanning signals 20 hitting object targets 22 of an object 18, for example the car with the trailer, are reflected. Those scanning signals 20 which are reflected in direction of the LiDAR system 14 are received with a receiving device of the LiDAR system 14.

An object target 22 in the sense of the invention is an area or a reflection point of an object 18 from which scanning signals 20 may be reflected. An object 18 may have one or more such object targets 22. For the sake of clarity, only a few object targets 22 of the objects 18 are shown as examples in the figures.

With means of the LiDAR system 14 the electromagnetic scanning signals 20 are transformed to object target data (Φ, Θ, D, I). Each object target data (Φ, Θ, D, I) comprises three position values for example characterizing a position of one object target 22 of the object 18 in the LiDAR reference system 24. The position values are the azimuth value Φ, the elevation angle value Θ and the distance value D. The azimuth value Φ and the elevation angle value Θ each characterize a respective direction of the object target 22 in relation to the coordinate origin of the LiDAR reference system 24. The distance value D characterizes a distance of the object target 22 from the coordinate origin of the LiDAR reference system 24. Further each object target data (Φ, Θ, D, I) comprises an intensity value I characterizing an intensity of the received scanning signal 20.

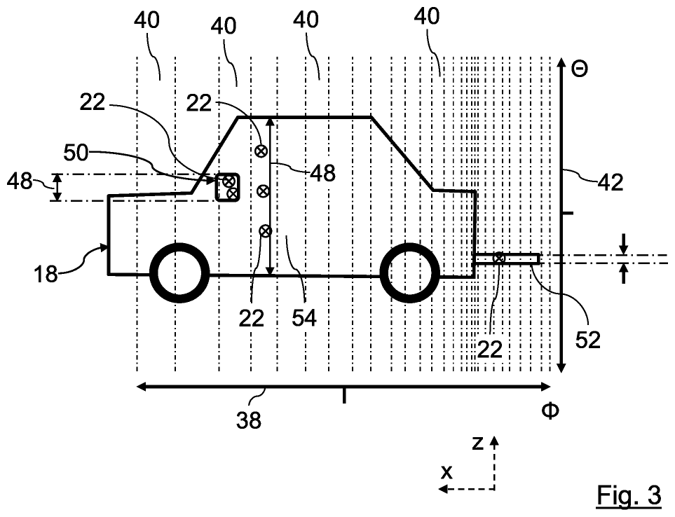

The scanning signals 20 are used to scan the monitoring area 16 so that a plurality of object target data (Φ, Θ, D, I) each characterizing one object target 22 is determined. FIG. 3 shows the object 18 (car) in a side view in the field of view, namely the horizontal field of view 38 and the vertical field of view 42, of the LiDAR system 14.

Thereafter, a set of contour target data (Φ*, D*, I*) characterizing a contour of the object 18, for example the car, is determined for example by computation from the object target data (Φ, Θ, D, I). For this purpose, object target data (Φ, Θ, D, I) resulting from object targets 22 in different vertical heights are combined to a set of contour target data (Φ*, D*, I*). The vertical heights are characterized by the elevation angle Θ. That is, the dimension of the contour target data (Φ*, D*, I*) is reduced by one compared to the dimension of the object target data (Φ, Θ, D, I). Each contour target data (Φ*, D*, I*) comprises a contour azimuth Φ*, a contour distance D* and a contour intensity I *.

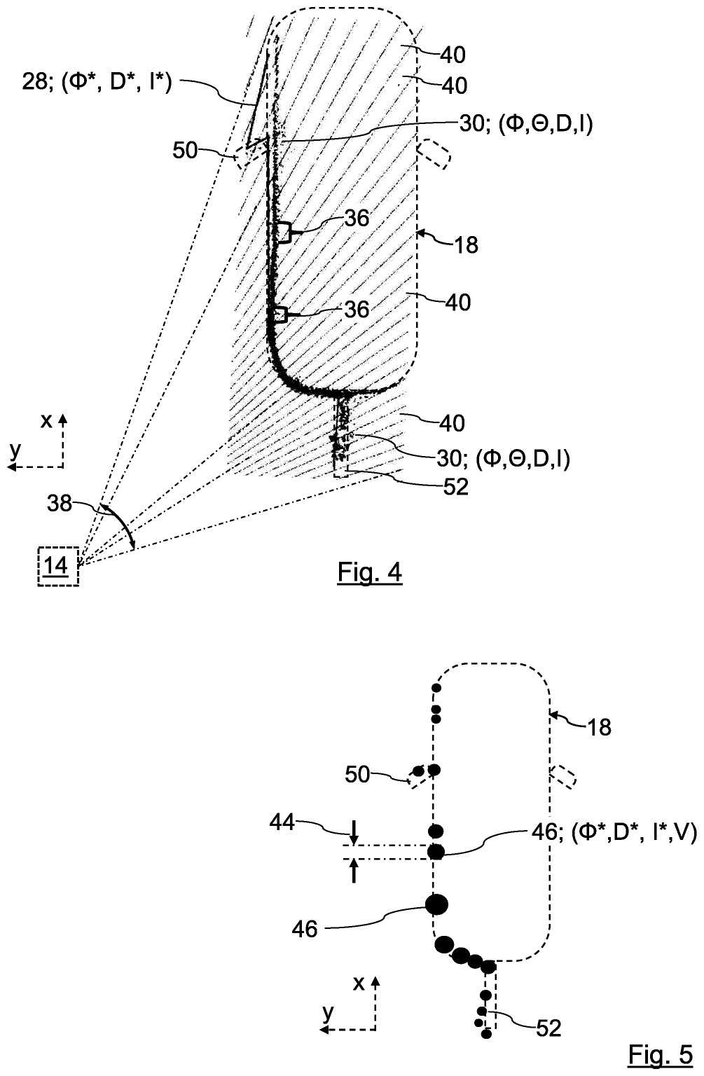

In FIG. 4, a point cloud with object target data points 30, each visualizing an object target data (Φ, Θ, D, I) of an object target 22, are shown in a two-dimensional view. For sake of clarity only a few object target data points 30 are marked. The set of contour target data (Φ*, D*, I*) characterizing the contour of the object 18, namely the car, is shown as a solid line 28. The line 28 consists of many contour data points each representing a contour target data (Φ*, D*, I*). For easier orientation, a top view of the object 18 is shown dashed.

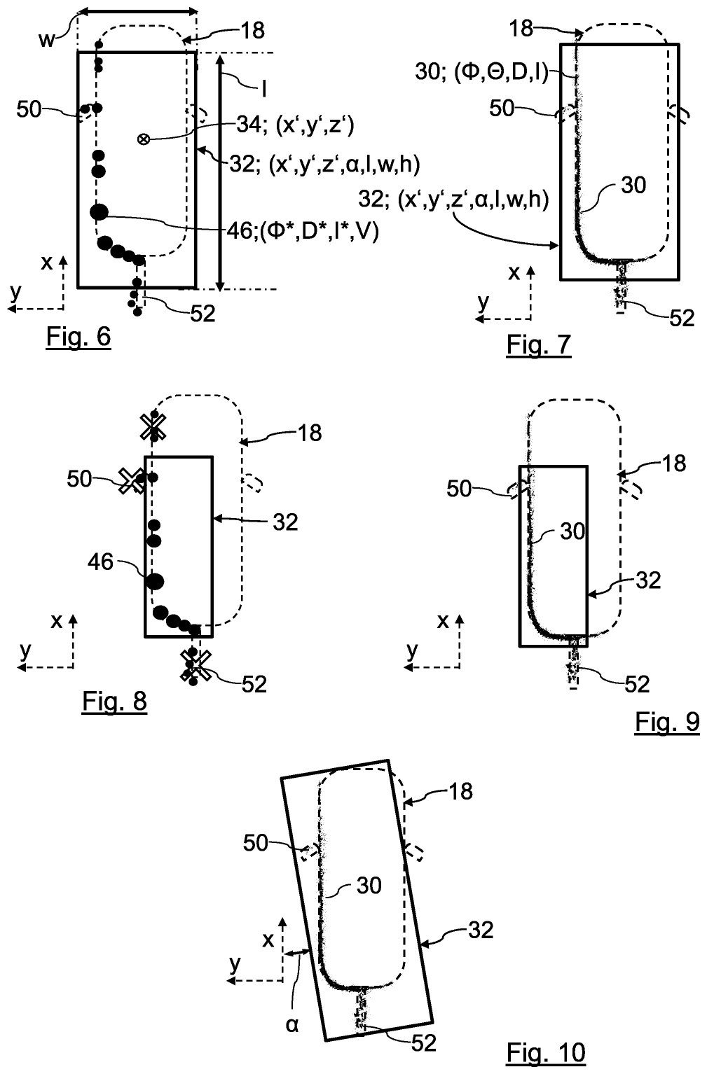

Then, a bounding data (x′, y′, z′, α, l, w, h) is computed from the set of contour target data (Φ*, D*, I*). The bounding data (x′, y′, z′, α, l, w, h) is used for characterizing a tracking area in form of a tracking box 32. FIGS. 6 to 10 illustrate exemplary tracking boxes 32.

Exemplary, the bounding data (x′, y′, z′, α, l, w, h) has the form of a tuple. Each bounding data (x′, y′, z′, α, l, w, h) comprises three position values, namely x′-y′-z′-coordinates of a reference point of the tracking box 32, for example a center 34 of the tracking box 32, in the vehicle coordinate system 26. Additionally, each bounding data (x′, y′, z′, α, l, w, h) comprises an orientation value, namely a yaw angle a, which characterizes the orientation of the tracking box 32 in the vehicle coordinate system 26. Further, each bounding data (x′, y′, z′, α, l, w, h) comprises three size values, namely a length l, a width w and a height h of the tracking box 32.

The height h of the tracking box 32 is not indicated in the two-dimensional representations of FIGS. 6 to 10.

To determine the bounding data (x′, y′, z′, α, l, w, h), the set of contour target data (Φ*, D*, I*) is grouped into clusters 36. Therefore, the horizontal field of view 38 of the LiDAR system 14 is divided into field of view sectors 40. Each field of view sector 40 extends over the whole vertical field of view 42 of the LiDAR system 14. In FIGS. 3 the horizontal field of view 38 of the LiDAR system 14 and the field of view sectors 40 are depicted. FIG. 4 shows the vertical field of view 42 and the field of view sectors 40. Contour target data (Φ*, D*, I*) resulting from object targets 22 in the same field of view sector 40 are grouped in the same cluster 36.

For the contour target data (Φ*, D*, I*) of each cluster 36 a weighting value V is determined from the contour target data (Φ*, D*, I*) of the respective cluster 36. FIG. 5 shows weighting points 46 illustrating the weighted contour target data (Φ*, D*, I*, V) weighted with the weighting values V of the clusters 36 in the two-dimensional top view. For easier orientation, the top view of the car 18 is shown dashed. The diameter 44 of the weighting points 46 each correspond to the size of the weighting values V.

For determination of the weighting value V for the contour target data (Φ*, D*, I*) of one cluster 36 one of the following criteria or a combination of the criteria are used:
the number of object target data (Φ, Θ, D, I) in the cluster 36
an extension of a range of height values, for example elevation angles O, of the object target data (Φ, Θ, D, I) of the cluster 36 characterizing a height extension 48 of the object targets 22 to which the object target data (Φ, Θ, D, I) of the cluster 36 belong,
a correlation of the position values of the object target data (Φ, Θ, D, I) of the cluster 36 with respect to each other characterizing an alignment of the object targets 22 to which the object target data (Φ, Θ, D, I) of the cluster 36 belong with respect to each other
a cluster position value which characterizes the position of the cluster 36 in relation to the other clusters 36.

In FIG. 3 exemplary a height extension 48 of a cluster 36, in which the object targets 22 of a side mirror 50 of the object 18 (car) are located, a height extension 48 of a cluster 36, in which the object targets 22 of a towbar 52 of the object 18 are located, and a height extension 48 of a cluster 36, in which the object targets 22 of a driver door 54 are located, are marked.

The enumerated criteria can be taken into account by using statistical quantities like mean values and variances. Therefore, the weighting values V for the contour target data (Φ*, D*, I*) of each cluster 36 are determined by statistical methods.

The bounding data (x′, y′, z′, α, l, w, h) is determined from the weighted contour target data (Φ*, D*, I*, V). The weighted contour target data (Φ*, D*, I*, V) each are determined from the respective contour target data (Φ*, D*, I*) weighted by the weighting value V of the cluster 36 to which the target data belongs. Weighting the contour target data (Φ*, D*, I*) reduces the influence of those target data that originate from irregular object targets 22, for example the mirror 50 or the towbar 52, on the bounding data (x′, y′, z′, α, l, w, h) is reduced.

The tracking box 32 with the bounding data (x′, y′, z′, α, l, w, h) for the object 18, namely the car, and the weighting points 46 from FIG. 5 are depicted in a top view in FIG. 6. FIG. 7 shows the tracking box 32 and the object data points 30 from FIG. 4.

The object 18, namely the car, is tracked with the LiDAR system 14 by tracking the tracking box 32. Tracking the tracking box 32 means determining a development of the bounding data (x′, y′, z′, α, l, w, h).

Optionally, only those weighted contour target data (Φ*, D*, I*,V) can be considered for determining the bounding data (x′, y′, z′, α, l, w, h) whose weighting values V lie within a predetermined range of values, for example above a predetermined threshold. This reduces the amount of data to be processed. The respective tracking box 32 for the object 18, namely the car, and the weighting points 46 from FIG. 5 are depicted in FIG. 8. The weighting points 46 whose weighting values V are below the threshold were not considered for the determination of the tracking box 32 and are crossed out with a cross each. FIG. 9 shows the respective tracking box 32 and the object data points 30 from FIG. 4.

For comparison only, FIG. 10 shows a tracking box 32 obtained by a method known in the prior art without the weighting with the weighting values V, and the object data points 30 from FIG. 4.

1. A method for tracking of at least one object with at least one detection device, the method comprising:
determining by use of electromagnetic scanning signals a plurality of target data,
wherein each target data comprises at least one position value characterizing a position of an object target (22) of the at least one object in at least one predefined reference system;
determining from at least a part of target data at least one bounding data, which characterizes a shape of the at least one object;
tracking the at least one object by determining a development of the at least one bounding data,
wherein determining the at least one bounding data at least a part of target data is grouped into clusters;
determining at least one weighting value for the target data of at least one cluster from the target data of the respective cluster; and
determining the at least one bounding data from weighted target data,
wherein the weighted target data each are determined from the respective target data weighted by the at least one weighting value of the cluster to which the target data belongs.

2. The method according to claim 1, further comprising:
determining at least one weighting value for the target data of at least one cluster from a number of target data in the at least one cluster, and/or from an extension of a range of comparable position values of target data of the at least one cluster, at least in one dimension,
wherein the extension of a range of position values characterizes a spatial extent of a distribution of the object targets to which the target data of the at least one cluster belong, and/or from a correlation of the position values of at least a part of target data of the at least one cluster with respect to each other, wherein the correlation characterizes an alignment of the object targets to which the target data of the at least one cluster belong with respect to each other, and/or from a cluster position value which characterizes the position of the cluster in relation to at least a part of the other clusters.

3. The method according to claim 1, wherein at least one weighting value for target data, of at least one cluster is determined by statistical methods, wherein the at least one weighting value is determined from mean values and/or variances.

4. The method according to claim 1, wherein for determining the at least one bounding data only those target data are considered whose weighting values lie within a predetermined range of values, wherein the predetermined range of values lie above a predetermined threshold or below a predetermined threshold.

5. The method according to claim 1, further comprising:
determining a plurality of object target data each characterizing one object target of the at least one object by use of electromagnetic scanning signals,
determining at least one contour target data characterizing a contour of the at least one object from at least a part of the object target data, and
determining the at least one bounding data from the at least one contour target data.

6. The method according to claim 5, further comprising:
determining a plurality of object target data each comprising at least one position value characterizing a three-dimensional position of one object target by use of electromagnetic scanning signals, for determining at least one contour target data the a dimension of at least a part of the object target data is reduced by one.

7. The method according to claim 1,
wherein at least a part of the at least one bounding data is used for characterizing at least one tracking area which is used for tracking the at least one detected object, and/or
wherein at least one bounding data comprises at least one position value, which characterizes a position of a tracking area which is used for tracking the at least one detected object relative to at least one reference system, and/or at least one orientation value, which characterizes an orientation of the tracking area in the at least one reference system, and/or at least one size value, which characterizes a size of the tracking area.

8. The method according to claim 1,
wherein at least one target data is determined which comprises at least one position value and/or a distance value, which characterizes a position of an object target in the at least one reference system and/or at least one intensity value which characterizes the intensity of electromagnetic scanning signals which have been reflected at the object target.

9. The method according to claim 1,
wherein at least one target data is determined which comprises at least one position value which characterizes a two-dimensional position of an object target in at least one two-dimensional reference system or which comprises at least one position value which characterizes a three-dimensional position of an object target in the at least one three-dimensional reference system.

10. A detection device of a vehicle, comprising:
means for sending electromagnetic scanning signals;
means for receiving reflected electromagnetic scanning signals; and
means for determining target data for object targets of objects from electromagnetic scanning signals; and
means for carrying out the method according to claim 1.

11. A vehicle with at least one detection device, wherein the at least one detection device comprises means for sending electromagnetic scanning signals, means for receiving reflected electromagnetic scanning signals and means for determining target data for object targets of objects from electromagnetic scanning signals, wherein the vehicle comprises means for carrying out the method according to one of the claim 1.
